(19) United States
(12) Patent Application Publication
(10) Pub. No.: US 2004/0138023 A1
(43) Pub. Date: Jul. 15, 2004

(54) Dual crankshaft engine coupling device

(76) Inventors: Thomas S. Moore, Oxford, MI (US); Brian P. Gebby, Ferndale, MI (US)

Correspondence Address: Thomas A. Jurecko, DaimlerChrysler Intellectual Capital Corporation, CIMS 483-02-19, 800 Chrysler Drive, Auburn Hills, MI, 48326-2757, US

(21) Appl. No.: 10/339,538

(22) Filed: Jan. 9, 2003

(51) Int. Cl. B60K 5/08

(52) U.S. Cl. 477/2

(57) ABSTRACT

A dual displacement engine system is provided including a first crankshaft for providing driving torque to a transmission and a second crankshaft that can be utilized to supplement the driving torque of the first engine crankshaft to meet higher torque demand requirements. An overrunning clutch device is provided for introducing the torque provided by the secondary engine crankshaft.

### FIELD OF THE INVENTION

The present invention relates to a power unit for a vehicle and more particularly, a dual crankshaft engine coupling arrangement.

### BACKGROUND AND SUMMARY OF THE INVENTION

Internal combustion engines have been used for many years for providing motive power for driving a vehicle. Most vehicles on the road today are provided with either a four, six, or eight cylinder internal combustion engine which is selected based upon the typical torque demand requirements for the individual type vehicle being designed. For example, four cylinder engines are typically used for commuter vehicles which are compact and typically have low load requirements and limited performance expectations. Six cylinder and eight cylinder engines are typically employed in larger vehicles wherein larger load carrying capacity and higher performance are expected. Some of the existing vehicle designs have suffered from low fuel efficiency due to the fact that the internal combustion engine for the vehicle has to be designed with a sufficient capacity to meet the high torque demands that are only occasionally required.

The dual displacement engine of the present invention overcomes these deficiencies by providing a powertrain system that includes a dual engine system with one of the engine portions being independently operable for providing driving torque to a transmission while the second engine portion can be utilized to supplement the driving torque of the first engine portion to meet higher torque demand requirements. Operation of the dual engine system is provided such that during normal driving at constant speeds and typical driving loads, the first engine portion is utilized for providing driving torque to the wheels of the vehicle. During periods of operation where increased levels of torque are required, such as during acceleration, pulling a heavy load, or climbing a hill, the second engine portion is operated in conjunction with the first engine portion for meeting the higher torque demand requirements. A coupling device is provided including an overrunning clutch in driving engagement with a drive member drivingly connected to the second crankshaft while an output shaft is in driving engagement with the first crankshaft and the overrunning clutch.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a schematic view of a vehicle powertrain system incorporating a dual engine crankshaft coupling arrangement according to the principles of the present invention;

FIG. 2 is a cross-sectional view of a coupling device for coupling a first and second crankshaft of a dual engine system according to the principles of the present invention;

FIG. 3 is a schematic view of a vehicle powertrain system incorporating a dual engine crankshaft coupling arrangement according to a second embodiment of the present invention;

FIG. 4 is a cross-sectional view of a coupling device for a dual engine crankshaft system according to the second embodiment of the present invention;

FIG. 5 is a schematic diagram of the layout of the dual crankshaft system of the engine shown in FIG. 1; and

FIG. 6 is a diagram of a control system of the dual engine power train system according to the principles of the present invention.

### DETAILED DESCRIPTION OF THE PREFERRED EMBODIMENTS

The following description of the preferred embodiment(s) is merely exemplary in nature and is in no way intended to limit the invention, its application, or uses.

With reference to FIG. 1, a vehicle 10 is shown provided with a power train system 12 including a dual displacement engine 14 (which will be described in greater detail herein) connected to an automatic transmission 16. A pair of drive wheels 20 are drivingly connected to the transmission 16 via a differential 22.

The dual displacement engine 14, as illustrated in FIG. 5, includes a primary engine portion 14A including a primary or first crankshaft portion 24 having a plurality of pistons 26 connected thereto by corresponding connecting rods 28. Each of the pistons 26 are disposed in a corresponding cylinder 30 as is well known in the engine art. For purposes of illustration, four pistons 26 are mounted to the first crankshaft portion 24, although it should be understood that more or fewer pistons can be connected to the first crankshaft portion 24 without departing from the spirit and scope of the present invention.

With continued reference to FIG. 5, a secondary engine portion 14B including a second crankshaft portion 32 is drivingly coupled to the first crankshaft 24 by an overrunning clutch device 34. A plurality of pistons 36 are connected to the second crankshaft 32 by corresponding connecting rods 38. Each of the pistons 36 are disposed in a corresponding cylinder 42 as is well known in the engine art.

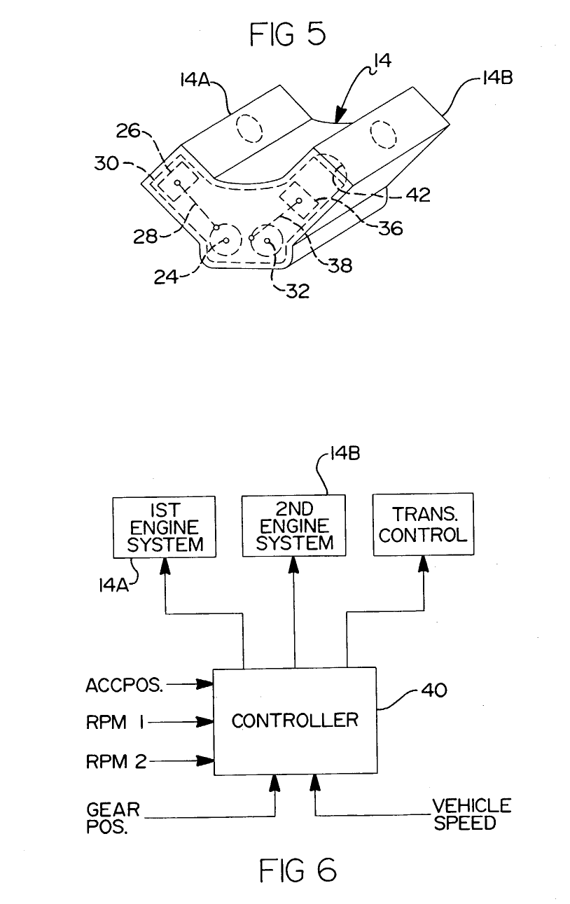

A central processor unit 40 (FIG. 6) is provided for controlling the transmission 16, as well as the primary and secondary engine systems 14A, 14B.

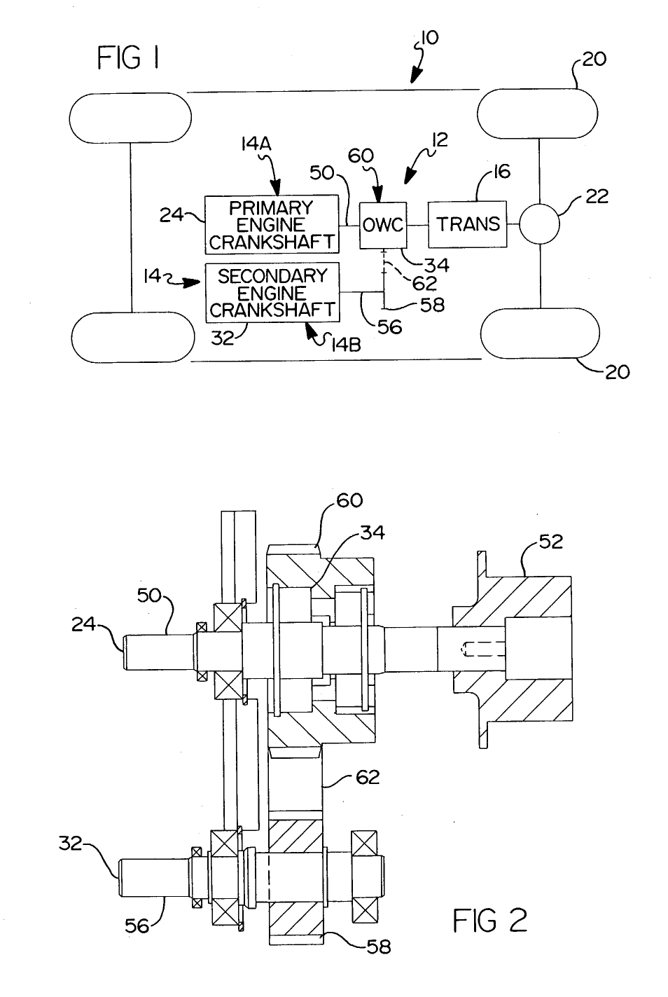

A first embodiment of the coupling device, according to the principles of the present invention, is shown in FIG. 2. The coupling device 34 couples the two engine crankshafts 24, 32 in parallel such that a primary engine, connected directly to a transmission can be used to propel a vehicle for a majority of its operating time, and a second engine crankshaft can be coupled to the first engine crankshaft via the overrunning clutch device 34 when additional power is needed for rapid accelerations or high load operating conditions.

As shown in FIG. 2, the primary engine crankshaft 24 is connected to a first input shaft 50 which is connected to an output coupling 52, which is adapted to be connected to an input shaft of transmission 16. A second input shaft 56 is connected to the second crankshaft 32. A drive sprocket 58 is fixedly mounted to the second input shaft. A driven sprocket 60 is mounted on the first input shaft 50. The overrunning clutch 34 is mounted inside a hub portion and the driven sprocket. A drive chain 62 is connected between the drive sprocket 58 and driven sprocket 60. When the speed of the driven sprocket 60 is equal to the speed of the first input shaft 50, the overrunning clutch 34 delivers torque to the first input shaft 50.

When it is determined by the central processor unit 40, based on the driver's throttle pedal 96 position and movement, that the non-running secondary engine 14B is needed to provide additional power to assist the primary engine 14A, the non-running secondary engine 14B can be started, brought up to the speed of the running primary engine 14A, and used to supplement the torque provided by the primary engine. At a specific desirable speed threshold of the secondary engine crankshaft 32, the secondary engine 14A is provided fuel, air, and ignition control via the central processor unit 40 so that the second engine 14B runs at a desired speed to provide needed torque.

To turn off the secondary engine 14B, it is only necessary to turn off the ignition and fuel to the secondary engine 14B.

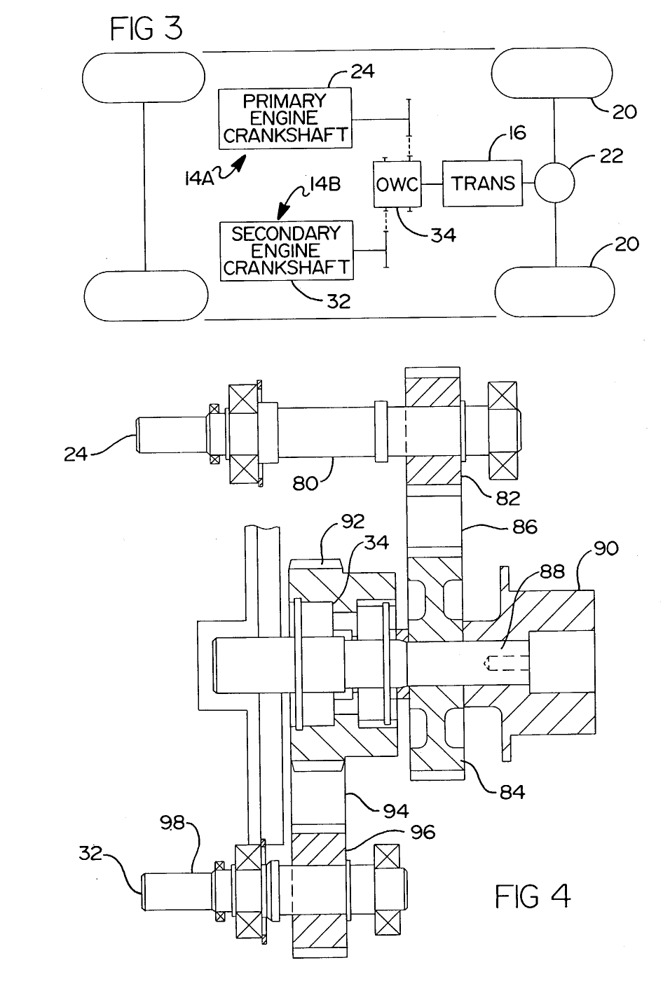

According to an alternative embodiment, as illustrated in FIG. 3, each of the primary and secondary engine crankshafts 24,32 are axially offset from the overrunning clutch 34. Specifically, a primary engine crankshaft 24 is connected to a first input shaft 80 having a first drive sprocket 82 mounted thereon. First drive sprocket 82 is drivingly connected to a first driven sprocket 84 by a drive chain 86. The first driven sprocket 84 is fixedly mounted to an output shaft 88 having an output coupling 90 adapted to be connected to an input shaft of a transmission 16. An overrunning clutch 34 is mounted within a driven sprocket 92 provided on the output shaft 88. The driven sprocket 92 is driven by a second drive chain 94 which is driven by a second drive sprocket 96 mounted to a secondary input shaft 98. The secondary input shaft 98 is connected to the secondary engine crankshaft 32.

During operation, the primary engine crankshaft 24 drives the first input shaft 80 which drives drive sprocket 82 for providing torque through the drive chain 86 to the first driven sprocket 84. The driven sprocket 84 is fixedly mounted to the output shaft 88 for providing torque to the transmission 16. When the vehicle controller 40 (FIG. 6) determines that additional torque is required, the secondary engine crankshaft engine 32 is started up and torque is delivered via the second input shaft 98, second drive sprocket 96, second driven chain 94, and driven sprocket 92 and to the overrunning clutch 34 for providing additional torque to the output shaft 88.

In each of the embodiments disclosed above, the overrunning clutch 34 can be of a sprag type, roller type, vane type, or any other overrunning clutch as is known in the art.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A dual input power transmission coupling device, comprising:
a first crankshaft;
a second crankshaft having a drive member drivingly connected to the second crankshaft;
an output shaft in driving engagement with said first crankshaft, said output shaft including a driven member mounted thereon in driving engagement with said drive member, said driven member including an overrunning clutch for transmitting torque to said output shaft when a speed of said driven member equals a speed of said output shaft.

2. The coupling device according to claim 1, wherein said first crankshaft and said output shaft are coaxial.

3. The coupling device according to claim 1, wherein said first crankshaft includes a drive member drivingly connected to a driven member on said output shaft.

4. The coupling device according to claim 1, wherein said first crankshaft and said second crankshaft, each includes a plurality of pistons connected thereto.

5. The coupling device according to claim 4, wherein said output shaft is connected to a transmission.

6. A dual input power transmission coupling device, comprising:
a first input shaft having a first drive sprocket mounted thereon;
a second input shaft having a second drive sprocket mounted thereon;
an output shaft having first and second driven sprockets mounted thereon;
a first chain drivingly engaged with said first drive sprocket and said first driven sprocket;
a second chain drivingly engaged with said second drive sprocket and said second driven sprocket; and
an overrunning clutch drivingly engaged with said second driven sprocket for imparting rotary motion to said output shaft.

7. The coupling device according to claim 6, wherein said first input shaft is connected to a first crankshaft and said second input shaft is connected to a second crankshaft, each crankshaft having a plurality of pistons connected thereto.

8. The coupling device according to claim 7, wherein said output shaft is connected to a transmission.
